(19) United States
(12) Patent Application Publication
(10) Pub. No.: US 2019/0021374 A1
(43) Pub. Date: Jan. 24, 2019

(54) Extruded Starch-Based Ready-to-Eat Snack and Methods of Making

(71) Applicant: Frito-Lay North America, Inc., Plano, TX (US)

(72) Inventor: Chun Lin LUO, Jiangsu Province (CN)

(21) Appl. No.: 15/652,778

(22) Filed: Jul. 18, 2017

(51) Int. Cl. A23L 7/117; A23L 5/10; A23P 30/20; A21D 13/043; A21D 13/047; A21D 10/00

(52) U.S. Cl. CPC A23L 7/117; A23L 5/10; A23P 30/20; A23V 2002/00; A21D 13/047; A21D 10/007; A21D 13/043

(57) ABSTRACT

There is provided an ambient-stable, packaged snack food product and methods of forming it by extrusion. The snack has a baked, porous body having a primary component including one or more of potato, legumes, pulses and cereals. The body of the snack includes from 40 to 85 wt. % of the primary component; optionally from 1.0 to 25 wt. % dairy powder; optionally from 5 to 18 wt. % of a sweetener, such as sugar; and from 5 to 25 wt. % oil. The body has a porosity of between 45 and 70%. It has a moisture content in the range 1-2 wt. %. In addition it has a viscosity, as tested, of less than about 200 cp, indicating a high proportion of cooked starch. It has a breaking point (for texture) in the range 10,000 to about 26,000 grams.

### BACKGROUND

### 1. Field of the Invention

The technology relates to a porous baked snack food that is shelf-stable at ambient temperatures. More particularly, the snack food is extruded, is starch-based, and has distinguishing organoleptic properties.

### 2. Description of the Related Art

In recent years there has been a great demand for snack foods as a convenience item, as people find less available time to make these. A variety of such foods are commercially available, and these fall into several categories. Some are “ready-to-eat” and may be eaten directly out of the package, or plated and eaten, or depending upon preference, heated before eating. Other snacks, that are not ready-to-eat, may require heating to ensure complete cooking or other preparation prior to consumption. Some snack foods are fried foods, while others are baked. Fried foods contain oil from the cooking process, and consumers in many parts of the world are expressing a desire for low oil-content snacks based on perceived health benefits. Baked foods, on the other hand, may have little or no oil.

Consumers have preferences that may vary widely from one individual to another. However, there are some organoleptic properties that in combination may appeal to a large segment of consumers. For example, as to the organoleptic property of texture, a slight crunchiness may be preferred to a hard crunchiness in certain snacks. In other snacks, a certain degree of porosity of the snack food may be preferred while in other snack foods, a smooth low porosity texture is preferred. Thus, a snack food of a particular type must meet consumer expectations for that particular type in terms of these properties.

Some of the more popular ready-to-eat out of the package snack foods are rich in starch content. For example, potato chips and tortilla chips. These are both now available as fried or baked snacks.

### SUMMARY

In an exemplary embodiment there is provided a baked, ambient-stable snack food product comprising:

a baked, porous body having, as a primary component, potato, legumes (pulses) and cereals, or a combination of these, the body comprising:
from 40 to 85 wt. % of the primary component;
optionally from 1.0 to 25 wt. % dairy powder;
optionally from 5 to 18 wt. % of a sweetener, such as sugar; and from 5 to 25 wt. % oil;

wherein the baked, porous body has a porosity of between 45 and 70%.

In a variation of this embodiment, the primary component comprises a mixture of potato flour or flakes, as well as other compositions, for example, flour from cereals, tapioca, pulses, and the like. In these embodiments, the other compositions are from 40 to 80 wt. % of the primary component, and the potato (whether flour or flakes) is from 1.0 to 20 wt. % of the primary component.

In another variation of the embodiment, the primary component may be derived from grains, beans or pulses, including, but not limited to, corn, rice, oats, wheat, tapioca, lentils, and mixtures thereof. In a yet further variant, the primary component is only potato, from flour or flakes, or both.

In addition, the embodiment and variations thereof may include from 3 to 15 wt. % seasonings. These seasonings include, but are not limited to salt, sugar, oil, yeast, edible flavors, and lecithin.

In exemplary embodiments the body of the snack, or a portion thereof, has a peak (breaking) force in the range from 10,000 to 30,000 grams, and preferably, 10,000 to 26,000 grams.

In exemplary embodiments, to improve mouthfeel, oil may be sprayed onto the outer surfaces of the snack food. The snack food may include from 3 to 20 wt. % oil that is sprayed or otherwise applied to surface of the snack food pieces after baking and drying.

The baked, ambient-stable snack food product may be in any of a variety of shapes, including but not limited to “stick” (long slender rectangular) or ring. Any extrudable shape that has consumers appeal can be used.

The baked, ambient stable snack food product can be covered with edible coatings, including but not limited to cheese, chocolate, flavorings of beef, chicken, barbeque and the like that have consumer appeal.

In focus group taste tests (described in the examples below) using a zero to 100 scale, the body of the inventive snack food had a mouthfeel hardness of 25, a mouthfeel crispiness of 35, mouthfeel crunchiness of 33 and a mouthfeel chewiness of 27, as explained here below.

Moreover, when samples of the body of the porous baked snack food are tested, as described herein using a Rapid Visco Analyzer (RVA), a peak viscosity of less than 200 cp is often obtained. A peak viscosity is preferably in the range 160 to 240 cp.

Also provided is an exemplary process of making the porous baked snack food, the process comprising the steps of:

making a dough including as a primary component a composition derived from potato, cereals, pulses or mixtures of these;

extruding the dough under pressure to produce a porous extrudate;

cutting the porous extrudate into pieces of porous dough;

baking the pieces of porous dough in an oven with a selected temperature profile to produce baked porous dough pieces; and

drying the baked porous dough pieces to a final product moisture content of from less than 4 wt. %, for example in the range 1.0 to 2 wt. %, to produce a porous snack food having a porosity of between 40 and 70%.

In a variant of the exemplary process, the step of making a dough comprises: mixing a dry mix comprising:

from 40 to 85.0 wt. % of a mixture of potato flour or flakes with a flour derived from one or more of cereals, pulses, and cassava, based on the dry mix weight;
optionally from 1 to 25 wt.% dairy powder, based on the dry mix weight; and

optionally from 5 to 18 wt. % sugar, based on the dry mix weight;

with liquids comprising:

from 1 to 10 wt. % oil, based on the dry mix weight; and
from 30 to 60 wt. % water, based on the dry mix weight.

In another variant of the exemplary process, the step of making a dough comprises: mixing dry mix ingredients comprising:
from 40 to 85.0 wt. % potato flour or flakes only, based on the dry mix weight;
optionally from 1 to 25 wt. % dairy powder, based on the dry mix weight;

optionally from 5.0 to 18 wt. % sugar, based on the dry mix weight; with liquids comprising:

from 1 to 6 wt. % oil, based on the dry mix weight; and
from 30 to 60 wt. % water, based on the dry mix weight.

In another variant of the exemplary process, the step of making a dough comprises: mixing dry mix ingredients comprising:

from 40 to 85 wt. % flour derived from one or more of cereals, pulses, and cassava, based on the dry mix weight;

optionally from 1 to 25 wt.% dairy powder, based on the dry mix weight;

optionally from 5.0 to 18 wt. % sugar, based on the dry mix weight; with liquids comprising:

from 1 to 10 wt. % oil, based on the dry mix weight; and from 30 to 60 wt. % water, based on the dry mix weight.

In exemplary embodiments the step of extruding may be carried out at ambient temperature (around 20-25 ° C.) and at an extrusion pressure of between 2.5 and 20 bars.

In exemplary embodiments, during the step of extruding, the dough expands in volume by from 5 to 80 vol. %.

In exemplary embodiments, the step of baking comprises baking in an oven having a temperature profile selected to minimize acrylamide production, the temperature profile starting at 180° C. when the dough enters, increasing to no more than 250° C., then decreasing to 180° C. when the baked dough is removed.

In exemplary embodiments, the step of drying comprises drying at 110° C. to reduce a moisture content of baked porous dough pieces to less than 4 wt. %, and preferably in the range 1 to 2 wt. %.

### BRIEF DESCRIPTION OF THE DRAWINGS

The foregoing aspects and many of the attendant advantages, of the present technology will become more readily appreciated by reference to the following Detailed Description, when taken in conjunction with the accompanying simplified drawings of exemplary embodiments. The drawings, briefly described here below, are not necessarily to scale, are presented for ease of explanation and do not limit the scope of the inventions recited in the accompanying patent claims.

FIG. 1 is a flowchart depicting an exemplary embodiment of a process for making the shelf-stable baked snack food of the invention.

FIG. 2 is a bar graph depicting peak force (grams) in comparative testing of texture for exemplary embodiments of the porous baked snack food against a commercial product.

FIG. 3 is a bar graph depicting viscosity (cp) in comparative testing of texture for exemplary embodiments of the porous baked snack food against a commercial product.

FIG. 4 is a graph depicting viscosity peaks, P, during comparative testing of exemplary embodiments of the porous baked snack food against a commercial product.

FIG. 5 is a table based on focus group testing of exemplary embodiments of the porous baked snack food against commercially available products.

FIG. 6A depicts a micro-CT image of a porous baked snack food in the form of a “stick.”

FIG. 6B depicts and a micro-CT image of the “stick” of FIG. 5A depicting porosity.

FIG. 6C depicts a micro-CT image of a ring-shaped embodiment of the porous baked snack food.

FIG. 6D depicts a micro-CT image of a commercially available “stick” snack product.

FIG. 6E depicts a micro-CT image of the “stick” of FIG. 5D depicting porosity.

### DETAILED DESCRIPTION

The following non-limiting detailed descriptions of examples of embodiments of the invention may refer to appended Figure drawings and are not limited to the drawings, which are merely presented for enhancing explanations of features of the technology. In addition, the detailed descriptions may refer to particular terms of art, some of which are defined herein, as appropriate and necessary for clarity.

Exemplary embodiments of the invention provide a shelf-stable, baked snack food. By “shelf-stable” it is meant that the snack food is stable for a period of time on shelfs in retail stores that ensures it can be purchased by consumers and would be “fresh,” without deterioration in its organoleptic properties, and be safe for human consumption. The period of time may range up to 6 months.

In exemplary embodiments, the shelf-stable baked snack food may be bite sized (or larger). By “bite sized” it is meant that an ordinary consumer can eat the snack in a single bite. Of course, the consumer may generally eat it in two to three bites, if he or she so chooses.

In exemplary embodiments that are potato-based, or that include potato as part of the main component, the potato used in a dough from which the shelf-stable baked snack food is made, may be either potato flour, potato flakes, or other form of dried, particulate potato.

In exemplary embodiments that are cereal grain based, or that include cereal as a part of the main component, the cereal used in making a dough from which the shelf-stable, baked snack food is made, may include but is not limited to, corn flour, wheat flour, oat flour, rice flour and tapioca flour.

In exemplary embodiments that are pulse-grain based, or that include pulses as a part of the main component, the pulse(s) used in making a dough from which the baked snack food is made, may include but is not limited to, red bean flour, lentil flour, chick-pea flour, and the like.

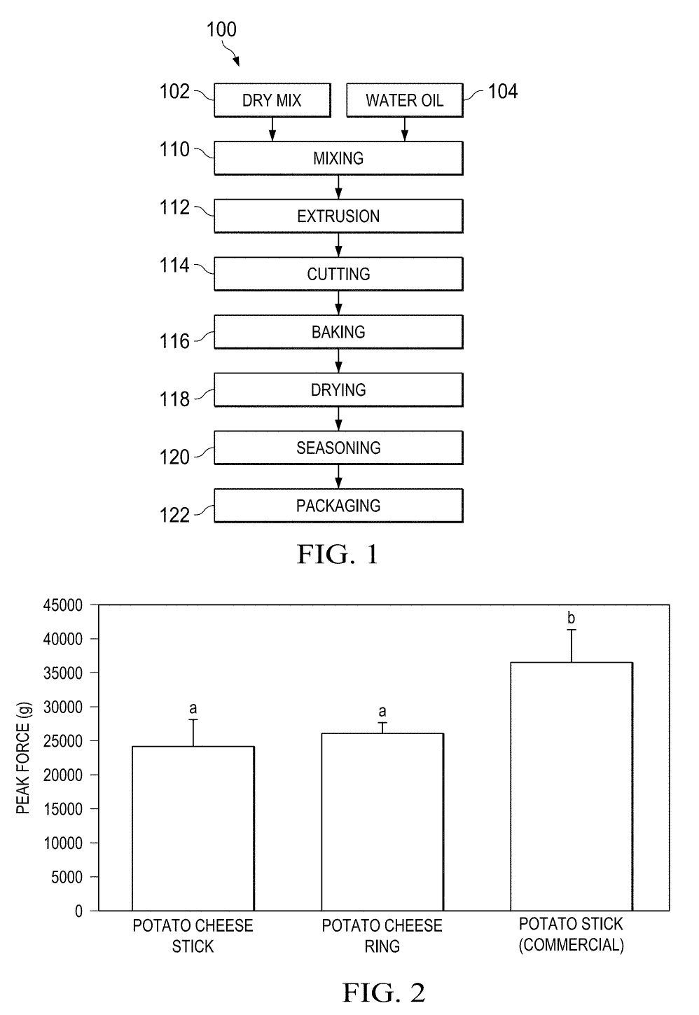

FIG. 1 is a flowchart depicting an exemplary embodiment of a process 100 for making the baked snack food of the invention. As depicted in this continuous process embodiment 100, a dry mix of ingredients (discussed below) is combined with water and oil in a mixing step 110. The mixing step may be carried out in apparatus used to make a dough, including, but not limited to a twin screw continuous mixer.

The dough exiting from the mixing step 110 enters an extrusion step 120. Here the dough is extruded into a desired shape under pressure in the range from 2.5 to 20 bars. During the extrusion 120, the dough expands volumetrically by from 50 to 80 vol. %.

The extruded dough is then subjected to cutting in step 114 to the desired size of each piece. These sizes may be bite-sized, or larger. The cut dough is conveyed on a conveyor for baking in step 116.

During baking 116, which can range from 1 to 7 minutes depending on factors, such as for example, dough piece size, and the selected temperature profile. Accordingly, if a continuous oven is used, the temperature at the dough entry region may be around 180° C., the temperature in the middle region of the oven may be around 240° C., and the temperature of the exit region may be lower, such as around 180° C. Of course, other temperatures and dwell times at these temperatures can also be useful. The moisture content of the baked dough exiting from the baking step 116 is in the range 4 to 15 wt. %, based on the dry snack food weight. Baked dough pieces are porous due to the expansion in the extrusion step. In general, the porosity after expansion is in the range 45 to 70%, and preferably greater than 45%.

The porous baked dough pieces are now routed on a conveyor to the drying step 118. Here the dough pieces are dried to a moisture content of less than 4 wt. %, or preferably in the range 1 to 2 wt. %. (It should be understood that depending upon configuration of equipment, the drying step may be carried out after baking in the same baking oven. A separate drying oven is not necessary but may be convenient.) Drying may be carried out at temperatures such as, for example, 50 to 120° C., typically for a period of time until the desired moisture content is achieved. This time is generally around 5 to 35 minutes, if at 110° C., but may be longer at lower temperatures, of course.

The dried, baked, snack food pieces are then routed by conveyor to a seasoning step 122 where seasoning may be applied to outer surfaces of the food pieces. As indicated before, the outer coating seasonings may be selected from a variety of flavors, textures and foods that find consumer acceptance. These include, but are not limited to salt, spices, cheese, chocolate, fruit flavorings, and other flavorings, such as for example, flavors of chicken or beef, barbeque meats, barbeque sauce, jalapeno, and the like that meet consumer preferences.

The dried, baked, seasoned snack food pieces are then transferred by conveyor to a packaging station, where packaging 122 takes place. The pieces are sealed into air-tight packages that may contain either one snack piece or several such pieces, depending upon size and consumer preferences.

The ingredients of the shelf-stable baked snack foods include several variants. In one variant, the primary component, is derived from potato only. In another variant the primary component is a flour derived from a non-potato source; i.e. derived from one or more of cereals, pulses, and cassava. In a further variant, the primary component includes mixtures of these derived flours with potato flour or flakes.

Thus, the dry mix ingredients of FIG. 1 may include from 40 to 85.0 wt. % of a primary component (which may include both potato flour and/or flakes as well as other non-potato derived fours) based on the dry mix weight; optionally from 5 to 18 wt. % sugar, based on the dry mix weight; optionally from 1 to 25 wt. % dairy powder, based on the dry mix weight. The water and oil added to make the dough includes from 5 to 25 wt. % oil, and from 30 to 60 wt. % water, based on dry ingredient weight.

More particularly, in a strictly potato-based variant, the dry mix ingredients may include from 40 to 85 wt. % potato flour or flakes (or mixture of flour and flakes); optionally from 5 to 18 wt. % sugar, based on the dry mix weight; optionally from 1 to 25 wt. % dairy powder, based on the dry mix weight. To this dry mix is added from 1 to 6 wt. % oil, based on the dry mix weight and from 30 to 60 wt. % water, based on dry ingredient weight.

In addition, in a variant that includes no potato but only flour derived from one or more of cereals, cassava (tapioca) and pulses, the dry mix ingredients of FIG. 1 may include from 40 to 85 wt. % of this derived flour or mix of flours. Examples of the derived flours include, but are not limited to, rice flour, wheat flour, oat flour, corn flour, tapioca flour, lentil flour, chick pea flour, and mixtures thereof. The dry mix further includes optionally from 5 to 18 wt. % sugar, based on the dry mix weight; optionally from 1 to 25 wt. % dairy powder, based on the dry mix weight. To make the dough, to this may be added from 1 to 10 wt. % oil, based on the dry mix weight, and from 30 to 60 wt. % water, based on the dry mix weight.

In a preferred embodiment, which has a primary component of potato, the baked, shelf stable snack food of the invention may be made from a dry mix having a composition in the range from 38 wt. % to 46 wt. % potato (such as potato flakes), from 12 to 16 wt. % oat flour, from 15 to 21 wt. % modified potato starch or modified corn starch; from 5 to 12 wt. % sugar, and from 15 to 21 wt. % dairy powder. To this may be added 3 to 10 wt. % oil and 35 to 45 wt. % water to make an extrudable dough. After cooking, as described herein, the product may be coated with 12 to 18 wt. % oil, and 3 to 8 wt. % seasonings and flavorings, as desired. The product has the physical and organoleptic properties as described herein.

For each of the variants, seasonings, flavorings and toppings may be added. For example, the shelf-stable, baked snack food may be covered with toppings and flavorings including but not limited to cheese, chocolate, flavorings of beef, chicken, barbeque, and a variety of other flavorings and toppings. And, seasoning, depending on type, may be added to the dough and/or to the baked and dried snack body surface. In addition, to improve mouthfeel, oil mist may be sprayed onto outer surfaces of the snack body, in amounts that suits consumer preference. In some instances, this may include from 5 to 25 wt. % oil, based on the weight of the snack food prior to oil application.

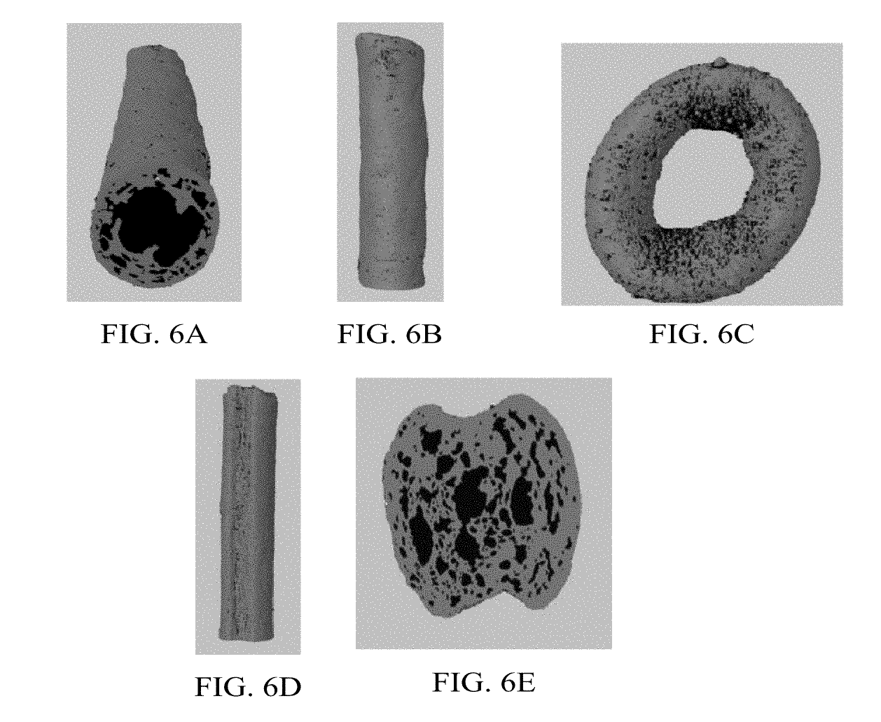

The shelf-stable baked snack food of the invention has several unique properties that set it apart from any commercially available snack food of the same type. For, example, the snack food pieces of the invention have a body that has a porosity in the range from 45 to 70%. In general, the porosity is at least 45%. This contributes to organoleptic properties such as texture and mouthfeel. As illustrated in FIGS. 6A-E, a potato based “stick” shaped snack of FIG. 6A, in accordance with the invention has a porosity shown in a micro-CT scan of FIG. 6B. This porosity visually can be seen to exceed that of a commercial product (FIG. 6D) which is shown in the micro-CT scan of FIG. 6E.

In addition to porosity, the shelf-stable baked snack foods of the invention also have other distinguishing features. For example, as to texture, the peak force in grams of the body of the snack food, or a piece of it, is in the range from 20,000 to 28,000 g for a stick shaped product, and from 24,500 to 27,500 g for a ring shaped product. Preferably, in the range from 20,000 to 27,500 g.

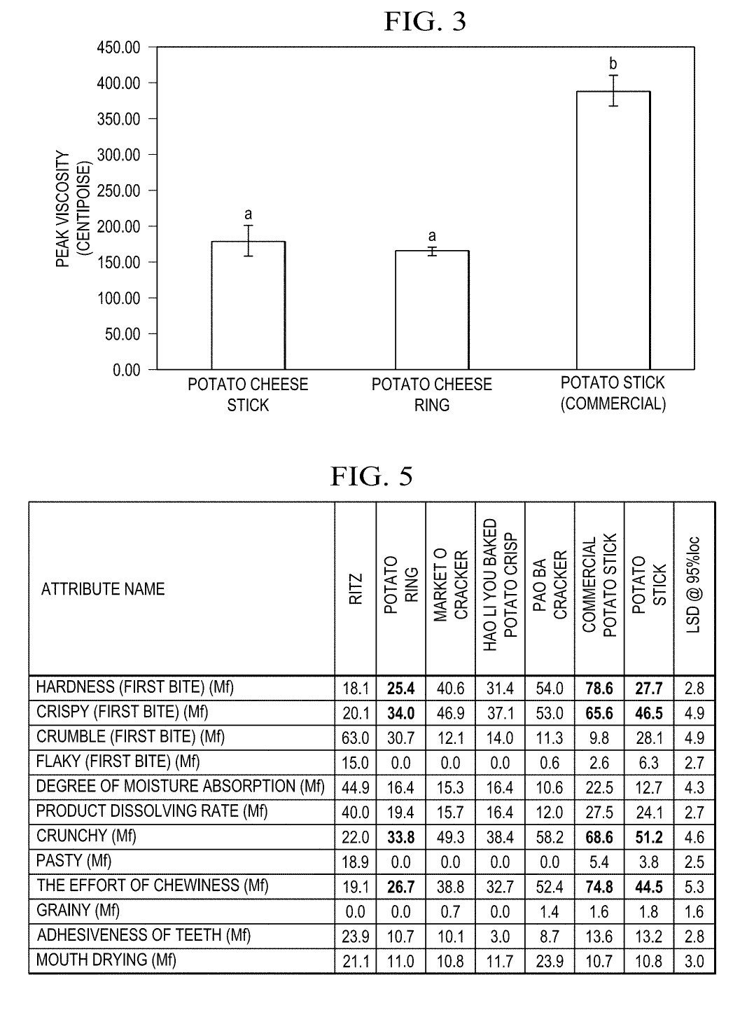

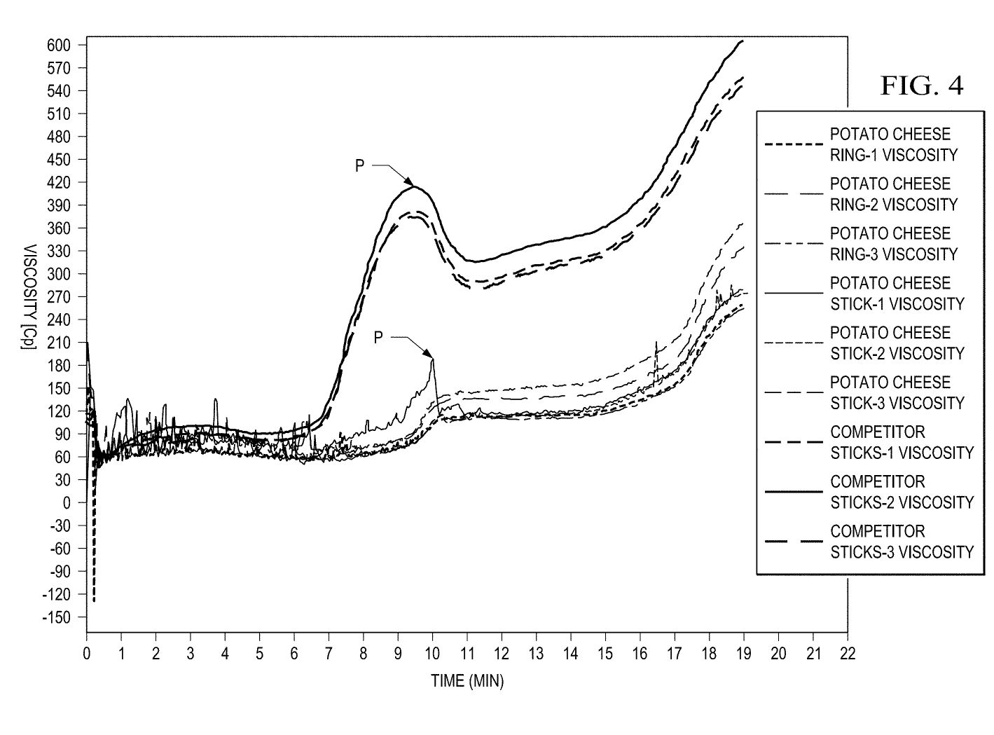

The snack foods of the invention have a higher proportion of cooked starch than Potato Wish. This can be derived from the peak viscosity of 150 to 180 cp, as compared to that Potato Wish at a peak of over 350 cp. See, bar graph of FIG. 3, plots of FIG. 4, and the explanation here below in the Examples.

In test conducted in focus groups, as illustrated in the Table of FIG. 5, the shelf-stable baked snack food showed several distinctive and distinguishing organoleptic properties, which include, on a scale of 0 to 100, a mouthfeel hardness of 25, a mouthfeel crispiness of 35, a mouthfeel crunchiness of 33 and a mouthfeel chewiness of 27. The differences between the inventive potato stick and potato ring as compared to the commercial potato stick is especially important.

### Examples

The following examples illustrate features of the invention, but it should be understood that the examples do not limit the scope of the invention.

### Comparative Example 1 (RVA Viscosity and % Gelatinized Starch)

Samples of a commercially available potato-based snack sold as Potato Wish by Orion of S. Korea was obtained. These were tested as a comparison to samples of snack pieces made in accordance with the invention. The tests were carried out on a Rapid Visco Analyzer (RVA) 4500 obtained from Instruments, Inc. of Springfield Ill., US. Tests were carried on the commercial samples and the inventive samples, according to instructions provided for the instrument.

The test results are graphically depicted in FIGS. 3 and 4.

From FIG. 3 it can be seen that the samples according to the invention have a lower viscosity, in the range 160 to 200 cp. On the other hand, the commercial samples have a viscosity between 370 and 410. This is a significant difference.

From FIG. 4 it can be seen that the peak (P) for the commercial samples and the samples according to the invention are significantly far apart. The samples according to the invention have peaks of less than 200 cp (around 180 cp) while the peak for the commercial sample is over 400 cp. This is also a significant difference.

The peak viscosity is inversely related to the proportion of starch that is gelatinized in the sample. Accordingly, a lower peak indicates a greater proportion of cooked starch. Thus, the samples according to the invention have a greater proportion of cooked starch.

### Comparative Example 2 (Texture and Peak Force)

Samples of a commercially available potato-based snack sold as Potato Wish by Orion of S. Korea was obtained. These were tested as a comparison to samples of snack pieces made in accordance with the invention. The tests were carried out on a TA.XT Plus Texture Analyzer by from Stable Micro Systems of Godalming, UK. Tests were carried on the commercial samples and the inventive samples, according to instructions provided for the instrument.

The results of the tests are shown in FIG. 2. As can be seen the bar graphs show that the samples failed under a peak pressure that differed significantly. The three samples according to the invention failed at around 25000 grams (g) (the rings at slightly over 25000, the sticks at under 25000). On the other hand, the commercial product samples failed at over 35000 g. This shows a significant difference in that the commercial product has greater “hardness” or “crunchiness,” which is also confirmed in the focus group test described here below.

### Comparative Example 3 (Focus Group)

A focus group including people was conducted. The members of the group were given samples of each of the products listed in the Table of FIG. 5 and were required to grade these, on a scale from zero to 100, comparatively as to the listed organoleptic properties, shown as “attribute name” on the Table. The results show that the potato-based samples made in accordance with the invention differed markedly from the commercially available potato stick that is the closest in snack food type. In particular, the inventive samples had a mouthfeel hardness of 25.4 (v. 78.6 for commercial) on a scale from 0 to 100, with 100 being hardest. It also had a mouthfeel crispiness (first bite with front teeth) of 35 (v. 65.6 for commercial), on a scale from 0 to 100, with 100 being most crisp, the more intense the sound, the more crisp the product. Further, it had a mouthfeel crunchiness of 33.8 (v. 68.6 for commercial) on a scale of 0 to 100, where chewing is with molars, and the more intense the sound, the higher the score. Additionally it had a mouthfeel chewiness of 26.8 (v 74.8 for commercial), on a scale of 0 to 100 where a higher score correlates to more effort to chew. Thus, it is clear that the samples according to the invention are not as crisp, not as hard, and are easier to chew.

While examples of embodiments of the technology have been presented and described in text and some examples also by way of illustration, it will be appreciated that various changes and modifications may be made in the described technology without departing from the scope of the inventions, which are set forth in and only limited by the scope of the appended patent claims, as properly interpreted and construed.

1. A baked, ambient-stable, packaged snack food product comprising:
a baked, porous body having a primary component, the body comprising:
from 40 to 85 wt. % of the primary component;
optionally from 5 to 18 wt. % sugar;
optionally from 1 to 25 wt. % dairy powder; and
from 5 to 25 wt. % oil;
wherein the baked, porous body has a porosity of at least 45%.

2. The snack food product of claim 1, wherein the primary component comprises a mixture of potato and one or more of cereal, pulses, cassava, and beans.

3. The snack food product of claim 1, wherein the primary component includes is selected from the group consisting of corn, rice, tapioca, pulses, and mixtures thereof

4. The snack food product of any of claim 1, wherein the primary component comprises 40 to 85 wt. % potato.

5. The snack food product of the foregoing claim 1, wherein the body is shaped as a ring.

6. The snack food product of claim 1, wherein the body has a cylindrical shape.

7. The snack food product of claim 1, wherein a texture peak force of the body, or a portion thereof, is in the range from 10,000 to 26,000 grams.

8. The snack food product of claim 1, wherein the porosity of the body is in the range 45% to 75%.

9. The snack food product of claim 1, wherein, on a zero to 100 scale, the body has a mouthfeel hardness of 25, a mouthfeel crispiness of 35, a mouthfeel crunchiness of 33 and a mouthfeel chewiness of 27.

10. The snack food product of claim 1, wherein a moisture content of the body is in the range 1 to 2 wt. %

11. The snack food product of claim 1, wherein a sample of the body tests to a peak viscosity in the range 160 to 240 cp.

12. The snack food product of claim 1, wherein a sample of the body tests to a peak viscosity less than 200 cp.

13. The snack food product of claims 1, having an oil on surfaces thereof.

14. A process of making a baked snack food, the process comprising the steps of:
making a dough including a primary component selected from flour or flakes derived from potato, cassava, cereals, pulses and mixtures thereof;
extruding the dough under medium pressure to produce a porous extrudate;
cutting the porous extrudate into pieces of porous dough;
baking the pieces of porous dough with a selected temperature profile to produce baked porous dough pieces; and
drying the baked porous dough pieces to a moisture content of from 1 to 2% by weight to produce a porous starch-based snack food.

15. The process of claim 14, wherein the step of making a dough comprises:
mixing a dry mix comprising:
from 40 to 85 wt. %, based on the dry mix weight, of a mixture selected from: potato flour, potato flakes, cereal flour, pulse flour, tapioca, and combinations thereof;
optionally from 5 to 18 wt. % sugar, based on the dry mix weight; and
optionally from 1 to 25 wt.% dairy powder, based on the dry mix weight; with liquids comprising:
from 30 to 60 wt. % water, based on the dry mix weight from 5 to 10 wt. % oil, based on the dry mix weight.

16. The process of claim 14 wherein the step of making a dough comprises mixing the following ingredients:
from 40 to 85 wt. % potato, as flour or flakes or mixtures thereof, based on the dry mix weight;
optionally from 5 to 18 wt. % sugar, based on the dry mix weight;
optionally from 1 to 25 wt. % dairy powder, based on the dry mix weight; with liquids comprising:
from 5 to 10 wt. % oil, based on the dry mix weight; and
from 30 to 60 wt. % water, based on the dry mix weight.

17. The process of claim 14 wherein the step of making a dough comprises mixing:
a potato-free dry mix comprising:
from 40 to 85 wt. % of cereal flour, pulse flour, and tapioca, based on the dry mix weight;
optionally from 5 to 18 wt. % sugar, based on the dry mix weight;
optionally from 1 to 25 wt. % dairy powder, based on the dry mix weight; with liquids comprising:
from 1 to 10 wt. % oil, based on the dry mix weight; and
from 30 to 60 wt. % water, based on the dry mix weight.

18. The process of claim 14, wherein the step of extruding is carried out at ambient temperature and at an extrusion pressure of between 2.5 and 20 bars.

19. The process of claim 14, wherein during the dough expands in volume by from 50 to 80 vol. %.

20. The process of claim 14, wherein the step of baking comprises baking in an oven having a temperature profile, the temperature profile starts at 180° C. when the dough enters, increases to no more than 250° C., then decreases to 180° C. when the baking is completed.

21. The process of claim 14, wherein the step of drying comprises drying at 110° C. to reduce a moisture content of baked porous dough pieces to the range 1 to 2 wt. %.
